(19) United States
(12) Patent Application Publication
(10) Pub. No.: US 2002/0017063 A1
(43) Pub. Date: Feb. 14, 2002

(54) Polishing liquid and process for patterning metals and metal oxides

(76) Inventors: Gerhard Beitel, Muhldorf/Inn (DE); Barbel Seebacher, Holzkirchen (DE); Annette Sanger, Dresden (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/858,422

(22) Filed: May 16, 2001

(30) Foreign Application Priority Data
May 16, 2000 (DE) 100 24 874.8

(51) Int. Cl. C09C 1/68; C09K 3/14

(52) U.S. Cl. 51/307

(57) ABSTRACT

The invention describes a polishing fluid for a chemical mechanical polishing process step, which contains a polycrystalline diamond powder and at least one additive from the group consisting of oxidizing agents, complex-forming agents, surfactants and organic bases. The polishing fluid according to the invention enables the abrasion rate for metal layers and metal oxide layers which contain in particular elements from group 8b of the periodic system to be increased.

Furthermore, the invention describes a process for planarizing and/or patterning a metal or metal oxide layer.

### DESCRIPTION

Polishing Fluid and Process for Patterning Metals and Metal Oxides

The invention relates to a polishing fluid which can be used, for example, for planarizing and/or patterning metal and metal oxide layers on a substrate by means of a chemical mechanical polishing process step. The invention also relates to a process for planarizing and/or patterning metals and metal oxides.

In order to be able to reproducibly read out the charge stored in a storage capacitor of a memory cell, the capacitance of the storage capacitor should be at least approximately 30 ff. At the same time, for the development of DRAM memory cells, the lateral extent of the capacitor has to be continuously reduced, in order to be able to further increase the storage densities. These inherently contradictory demands which are imposed on the capacitor of the memory cell lead to increasingly complex patterning of the capacitor (trench capacitors, stack capacitors, crown capacitors). Accordingly, fabrication of the capacitor is becoming increasingly complex and therefore increasingly expensive.

Another way of ensuring that the storage capacitors have sufficient capacitances is to use materials with a very high dielectric constant between the capacitor electrodes. Recently, therefore, new types of materials, in particular high-ε paraelectrics and ferroelectrics have been used as dielectric instead of the conventional material silicon oxide/silicon nitride, these new materials having a significantly higher relative dielectric constant (>20) than the conventional silicon oxide/silicon nitride (<8). In this way, it is possible, while maintaining the same capacitance, to considerably reduce the capacitor area and therefore the required complexity of patterning of the capacitor. Important representatives of these new types of materials with relatively high dielectric constants are barium strontium titanate (BST, (Ba, Sr)TiO₃), lead zirconate titanate (PZT, Pb(Zr,Ti)O₃) or lanthanum-doped lead zirconate titanate and strontium bismuth tantalate (SBT, SrBi₂Ta₂O₉).

As well as conventional DRAM memory modules, ferroelectric memory arrangements, known as FRAMs, will play an important role in the future. Compared to conventional memory arrangements, such as for example DRAMs and SRAMs, ferroelectric memory arrangements have the advantage that the information stored is not lost even in the event of an interruption to the voltage or current supply, but rather the information remains stored. This non-volatility of ferroelectric memory arrangements is based on the fact that, with ferroelectric materials, the polarization which is generated by an external electric field is substantially retained even after the external electric field has been switched off. The new materials which have already been mentioned, such as lead zirconate titanate (PZT, Pb(Zr,Ti)O₃) or lanthanum-doped lead zirconate titanate or strontium bismuth tantalate (SBT, SrBi₂Ta₂O₉) are also used for ferroelectric memory arrangements.

Unfortunately, the use of the new paraelectrics or ferroelectrics requires the use of new electrode and barrier materials. The new paraelectrics or ferroelectrics are usually deposited on existing electrodes (lower electrode). The processing takes place at high temperatures, at which the materials which the capacitor electrodes normally consist of, for example doped polysilicon, are readily oxidized and lose their electrically conductive properties, which would lead to the memory cell failing.

On account of its good resistance to oxidation and/or the formation of electrically conductive oxides, 4d and 5d transition metals, in particular precious metals such as Ru, Rh, Pd, Os, Pt and in particular Ir or IrO₂, represent promising candidates which could replace doped silicon/polysilicon as electrode and barrier material.

One problem is that the abovementioned electrode and barrier materials which are now being used in integrated circuits belong to a class of materials which can only be patterned with difficulty. On account of their chemical inertness, they can only be etched with difficulty, so that the etching abrasion, even when using “reactive” gases, results predominantly or almost exclusively from the physical part of the etching. By way of example, iridium oxide has hitherto generally been patterned by dry etching processes. A significant drawback of these processes is the lack of selectivity of the process on account of the high physical proportion of the etching. This means that, on account of the erosion of the masks, which inevitably have inclined flanks, it is only possible to ensure a low degree of dimensional accuracy of the patterns. Furthermore, undesirable Re deposits are formed on the substrate, on the mask or in the installation employed.

Furthermore, these materials have proven extremely resistant even to the use of CMP (chemical mechanical polishing) process. Standard CMP processes for planarizing and patterning metal surfaces exist, for example, for tungsten and copper, and also for the materials used as barrier layer, such as Ti, TiN, Ta and TaN. The CMP processes for planarizing polysilicon, silicon oxide and silicon nitride also belong to the prior art. However, the polishing fluids used in these processes are not suitable for the abrasion of precious metals. The problem of a CMP process for precious metals and their oxides, such as Pt, Ir or IrO₂, once again consist in the chemical inertness and difficulty of oxidizing these materials.

Furthermore, it has previously been attempted to polish precious metals, such as platinum, with the aid of aqueous suspensions of monocrystalline nanoparticles (i.e. particles with a size of less than 1 μm). Examples of nanoparticles which have been used are SiO₂, and A1₂O₃, cf. in this respect J. Haisma et al., Philips J. Res. 49 (1995), 23-46. In this case, the polishing operation takes place primarily by means of mechanical abrasion. To avoid aggregation of the abrasive particles and therefore the formation of scratches, organic liquids, such as for example glycerol or polyalcohols, are added. Drawbacks of the known polishing fluids are the low abrasion rates which they are able to achieve. A number of tests carried out using SiO₂, and A1₂O₃ as abrasive particles have shown that only with a high content of abrasive in the suspension can a low degree of abrasion be achieved. When using low abrasive contents (of the order of magnitude of slurries which are used for conventional oxide and tungsten CMP processes), it was not possible to determine any abrasion whatsoever. Furthermore, scratches are formed, which may arise, inter alia, as a result of agglomeration of the abrasive particles. The particle sizes which were tested lie in the range from 50 to 200 nm.

Therefore, the present invention is based on the object of providing a polishing fluid which can be used for the planarizing and/or patterning of metals and metal oxides and which ensures a sufficiently high abrasion rate.

This object is achieved by the polishing fluid as described in patent claim 1. The invention also provides a process for planarizing and/or patterning a metal oxide layer in accordance with patent claim 9. Further advantageous embodiments, configurations and aspects of the present invention will emerge from the dependent patent claims, the description and the exemplary embodiments.

The invention provides a polishing fluid, in particular for abrading and/or patterning metal oxides and metals, in particular elements from group 8b of the periodic system, by chemical mechanical polishing, which polishing fluid contains

a) water or a water/alcohol mixture,

b) polycrystalline diamond powder, and

c) at least one additive selected from the group consisting of oxidizing agents, complex-forming agents, surfactants and organic bases.

The polishing fluid according to the invention contains as liquid phase water or a water/alcohol mixture. This liquid phase ensures optimum wetting of the polishing plate, on the one hand, and the surface to be polished (e.g. the wafer), on the other hand.

Furthermore, the polishing fluid according to the invention contains polycrystalline diamond powder, the particle size of which is preferably below approximately 1 μm, in particular between 0.05 and 1 μm, and especially between 0.1 and 1 μm. Synthetically produced polycrystalline diamond powder has proven particularly suitable. Despite the relatively large particle diameter of the diamond particles, the polishing fluid according to the invention enables very smooth surfaces to be produced. With a typical polishing process using a polishing fluid which contained synthetic diamond particles with a particle size of 1 μm, it was possible to achieve a surface roughness of 3.5 nm (rms, measured using the AFM analysis method), with a maximum depth of individual scratches of 20 nm. One explanation for the relatively smooth surfaces which can be achieved with the polishing fluid according to the invention is that the polycrystalline diamond particles are readily broken up into smaller particles under mechanical load (polishing pressure), resulting in a correspondingly low scratch depth.

The polycrystalline diamond particles contained in the polishing fluid according to the invention results, as described above, in mechanical abrasion without deep scratches being formed on the surface which is to be polished. Furthermore, the addition of additives results in chemical abrasion on a metal or metal oxide surface. The additives are particularly effective if they are used in combination with surfaces which contain or consist of precious metals, such as elements from group 8b of the periodic system of the elements. The abovementioned precious metals include ruthenium (Ru), rhodium (Rh), palladium (Pd), osmium (Os), iridium (Ir) and platinum (Pt).

A first group of additives which can advantageously be used in the polishing fluid according to the invention is formed by oxidizing agents, in particular strong oxidizing agents such as oxygen, 0₃, H₂O₂ or peroxodisulfate in acid or alkaline solution, chlorine/oxygen compounds, such as for example hypochlorite, chlorate and perchlorate, bromine/oxygen compounds, such as for example bromate, iodine/oxygen compounds, such as for example iodate, manganese/oxygen compounds, such as for example permanganate, chromium/oxygen compounds, such as for example chromate, iron (III) compounds, such as for example Fe₂(SO₄), K₃Fe(CN)₆ and Fe(A)₃ where A=F, Cl, Br, I, or (NO₃), cerium (IV) compounds, such as for example Ce(SO₄)₂ and Ce(NO₃)₄, nitrohydrochloric acid and chromosulfuric acid, it being possible for the abovementioned oxidizing agents to be used alone or in combination. The use of the oxidizing agents results in oxide layers on the surface of the metals to be treated, so that it is possible to prevent further oxidation or the dissolution of the metal which is to be polished. This passivation of the surface which is effected by the oxidizing agent is eliminated again by mechanical abrasion, so that “fresh”, i.e. unoxidized metal surface can once again come into contact with the oxidizing solution. The sequence of oxidation/removal of the oxidized layer is then repeated until the desired level of abrasion has been reached.

However, it is also conceivable, in the case of chemical mechanical polishing processes, for mechanical abrasion to take place first, followed by chemical oxidation, i.e. for the mechanical abrasion to precede the chemical abrasion. Particularly when using precious metals, this sequence is in fact not unlikely, since rough surfaces and small clusters can be oxidized more easily. Moreover, some metals, such as for example Pt, do not form a passivating oxide layer.

A second group of additives which can expediently be used together with the polycrystalline diamond powder are complex-forming agents. In this context, it is necessary to distinguish specifically between two different methods of action of complex-forming agents.

Firstly, it is possible to use complex-forming agents which, by forming complexes with precious metal ions, reduce the normal potential of precious metals to such an extent that they can be attacked by oxidizing agents. One example of this would be the reaction

Pt²⁺+4 Cl³¹−[PtCl₄]²⁻

in which the normal potential E₀ is reduced from +1.2 V to +0.73 V. The addition of suitable complex-forming agents shifts the equilibrium between precious metal in elemental form and its ions in the solution toward the formation of new ions (e.g. Pt²⁺). The oxidation potential of the precious metal in the solution is reduced by the action of the complex formation, as is the case, for example, when metallic gold is dissolved by cyanide lye. When using a precious metal with reduced oxidation potential, chemical mechanical polishing is concluded more quickly, since reaction of the surface and abraded particles of the precious metal with the oxidizing agent employed takes place more quickly or becomes possible for the first time compared to polishing methods in which no complex-forming agent is used. Furthermore, it becomes possible to use weaker, less aggressive oxidizing agents. This has an advantageous effect, under certain circumstances, on the service lives of installations and on safety at work measures.

Examples of complex-forming agent which have this mechanism of action are chelating ligands in basic solution. These include EDTA (ethylenediaminetetraacetic acid), nitrogen-containing crown ethers, such as 1,4,8,11-tetraazacyclotetradecane derivatives (obtainable from Fluka as #86771 or #86733) and citric acid. Simple chloride, bromide or cyanide ligands (for example in the form of their alkali metal salts) can also have a corresponding effect.

A second type of complex-forming agent is used, for example, to prevent redeposition of the material (e.g. Pt) which has been mechanically removed from the surface and/or to prevent the formation of scratches. Scratches can be formed as a result of the mechanical action of relatively large particles on the surface which is to be machined. These larger particles in turn are formed by agglomeration of material which has been removed by mechanical polishing and possibly particles of the abrasive material. Redeposition and agglomeration of this type can be prevented by forming complexes with precious metal atoms or clusters. Examples of corresponding complex-forming agents are organometal coordination compounds based on phosphine ligands (PR₃, R=organic radical), which form stable precious metal complexes (e.g. Pt complexes).

Finally, it is advantageously possible to use a third group of additives together with the polycrystalline diamond particles in the polishing fluid according to the invention. Examples of this third group are surfactants or organic bases which reduce the surface tension of the polishing fluid and improve the wetting of the surface to be polished with polishing fluid. The reduction in the surface tension facilitates, inter alia, the removal of metal particles from the surface to be machined and of abrasive particles and polishing cloth residues.

As has already been mentioned, the particles in the polishing fluid are preferably nanoparticles, i.e. particles with a mean diameter of less than 1 μm. Furthermore, it is preferable for the proportion of abrasive particles (diamond powder) in the polishing fluid to be between 1 and 30% by weight.

The invention also provides a process for planarizing and/or patterning a metal oxide layer or metal layer containing metals from group 8b of the periodic system, which comprises the following steps:

a) a substrate is provided,

b) a metal oxide layer or a metal layer is applied,

c) a polishing fluid containing polycrystalline diamond powder is provided, and

d) the metal oxide layer or the metal layer is planarized and/or patterned by means of a polishing step with the aid of the polishing fluid.

The process according to the invention has the advantage that it can be used to pattern and/or planarize unpatterned precious-metal-containing surfaces which contain elements from group 8b of the periodic system of the elements with high abrasion rates.

In the process according to the invention, it is preferable to use polycrystalline diamond powders in the nano-range, i.e. with a particle size of less than approximately 1 μm. Polycrystalline diamond particles with a particle size of between 0.05 and 1 μm, in particular between 0.1 and 1 μm, are particularly suitable. It has proven particularly expedient to use synthetic polycrystalline diamond powder. The quantity of polycrystalline diamond powder in the polishing fluid used in the process according to the invention is preferably 1 to 30% by weight.

Furthermore, for chemical mechanical polishing (CMP) processes, it is advantageous if additives which assist the chemical component of the polishing process are added to the polishing fluid. Suitable additives are the oxidizing agents which have already been described in more detail above (e.g. oxygen, O₃, H₂O₂, peroxodisulfate in acid or alkaline solution, chlorine/oxygen compounds, such as for example hypochlorite, chlorate and perchlorate, bromine/oxygen compounds, such as for example bromate, iodine/oxygen compounds, such as for example iodate, manganese/oxygen compounds, such as for example permanganate, chromium/oxygen compounds, such as for example chromate, iron (III) compounds, such as for example Fe₂(SO₄)₃, K₃Fe(CN)₆ and Fe(A)₃ where A=F, Cl, Br, I or (NO₃), cerium (IV) compounds, such as for example Ce(SO₄)₂ and Ce(NO₃)₄, nitrohydrochloric acid and chromosulfuric acid, it being possible for the abovementioned oxidizing agents to be used alone or in combination), complex-forming agents (e.g. EDTA, nitrogen-containing crown ethers, citric acid, chloride ligands, bromide ligands, cyanide ligands and organometal coordination compounds based on phosphine ligands (Pr₃, where R represents an organic radical)) and surfactants or organic bases.

In the process according to the invention, the polishing pressure may preferably be set between 3.45 and 69 kPa (0.5 and 10 psi), in particular between 6.9 and 34.5 kPa (1 to 5 psi). The abrasion rates which can be achieved as a result, with a particle size of the polycrystalline diamond particles of approximately 1 μm, lie in the range between 5 and 60 nm/min, in particular between 20 and 50 nm/min.

The rotational speed of the polishing plate is preferably between 20 and 70 revolutions per minute (rpm). The customary polishing time is between about 2 and 10 min, in particular between about 3 and 5 min.

The invention is explained in more detail below with reference to figures of the drawing, in which:

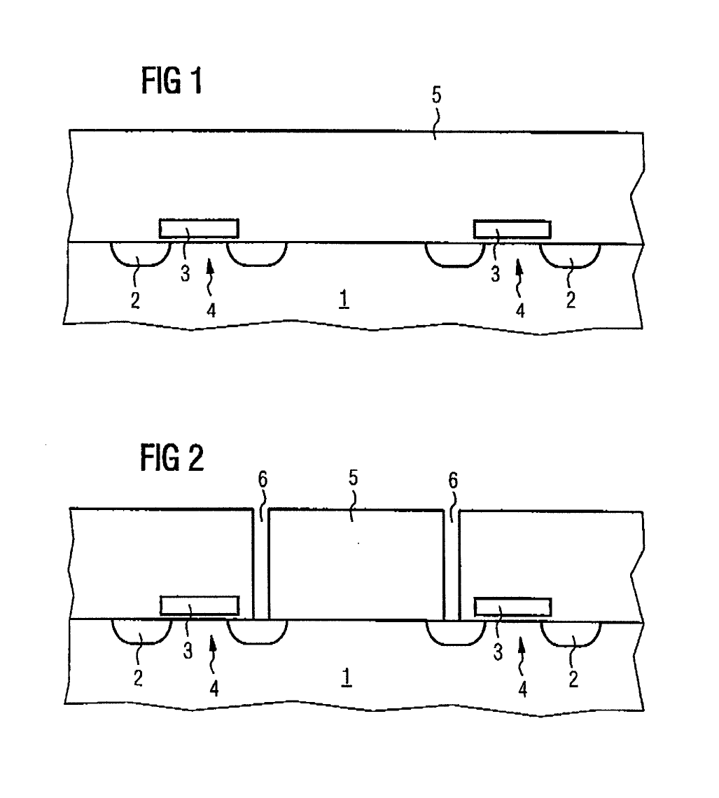

FIGS. 1-6 show a process for planarizing and/or patterning a metal oxide layer or a metal layer using an embodiment of the present invention.

FIG. 1 shows a silicon substrate 1 with transistors 4 which have already been fabricated. The transistors, together with the storage capacitors which are still to be fabricated, form the memory cells which serve to store the binary information. The transistors 4 each have two diffusion regions 2 which are arranged on the surface of the silicon substrate 1. The channel zones, which are separated by the gate oxide of the gate electrodes 3 on the surface of the silicon substrate 1, are arranged between the diffusion regions 2 of the transistors 4. The transistors 4 are fabricated using processes which are known in the prior art and are not explained in more detail here.

An insulating layer 5, for example an SiO₂ layer, is applied to the silicon substrate 1 with the transistors 4. Depending on the process used for the fabrication of the transistors 4, it is also possible to apply a plurality of insulating layers. The resultant structure is shown in FIG. 1.

Then, the contact holes 6 are produced by a photographic technique. These contact holes 6 produce a connection between the transistors 4 and the storage capacitors which are yet to be produced. The contact holes 6 are produced, by way of example, by anisotropic etching with fluorine-containing gases. The resultant structure is shown in FIG. 2.

Next, a conductive material 7, for example polysilicon doped in situ, is applied to the structure.

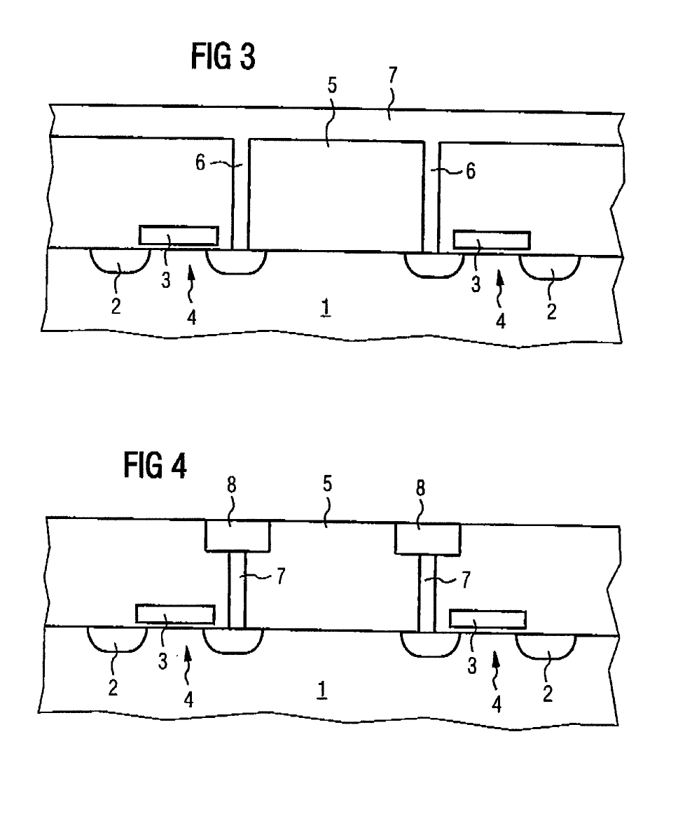

This can take place, for example by means of a CVD process. As a result of the application of the conductive material 7, the contact holes 6 are completely filled and a cohesive conductive layer is formed on the insulating layer 5 (FIG. 3). There then follows a CMP (chemical mechanical polishing) step, which removes the cohesive conductive layer on the surface of the insulating layer 5 and produces a planar surface.

Then, recesses are formed in the insulating layer 5 overlapping the contact holes 6 or only in the contact holes 6. As an alternative, it is also possible to produce recesses in a further insulating layer (not shown), which further insulating layer is deposited on the insulating layer 5 after the patterning of the conductive material 7.

These recesses are then filled with barrier material 8, for example iridium and/or iridium oxide, up to a predetermined height. This is implemented by depositing the barrier material 8 over the entire surface, for example with the aid of a sputtering process, and using a CMP step to polish it back to the surface of the insulating layer 5. To carry out the CMP step, a polishing fluid which contains polycrystalline diamond powder as abrasive particles is used. This concludes the process according to the invention. A metal and/or metal oxide layer has been patterned to form the barriers 8. The resultant structure is shown in FIG. 4.

In the text which follows, the structure shown in FIG. 4 forms the starting point for the further application of a process according to the invention. For this purpose, a mask layer of insulating material, for example of silicon oxide, is applied and is patterned by means of a photolithographic step in such a way that it is opened up in the region around the contact holes. The opened regions of the mask 9 define the geometry of the lower electrodes.

In this way, the first step a) of the process according to the invention is concluded again, i.e. a pre-patterned substrate, on which a metal layer is then deposited and patterned, has been provided. Then, a metal layer 10, for example a Pt layer, is deposited on the silicon oxide mask 9. The thickness of the conductive layer is selected in such a way that the openings in the silicon oxide mask 9 are completely filled. The resultant structure is shown in FIG. 5.

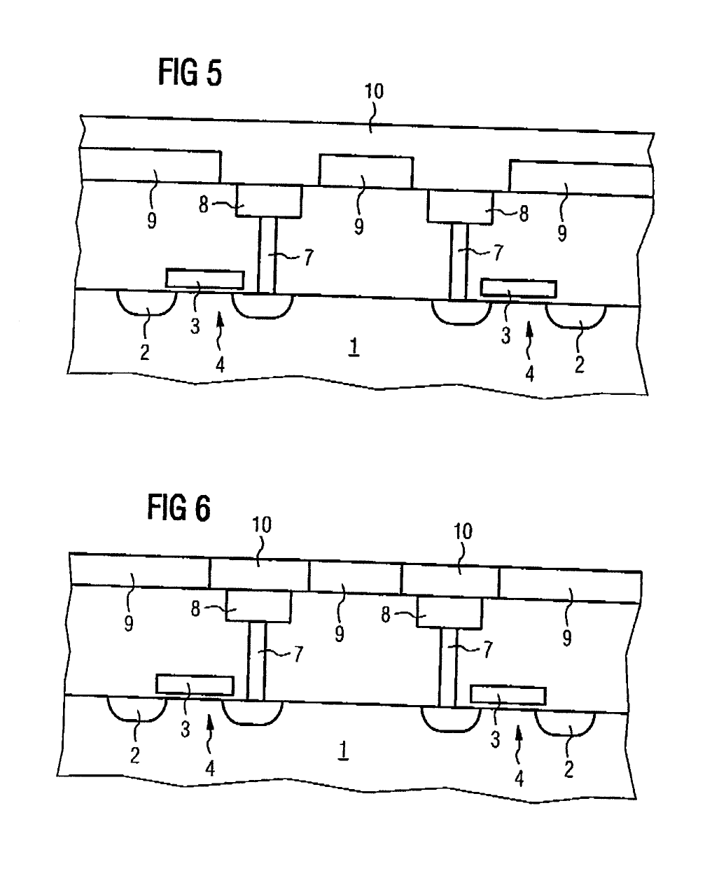

In a following CMP step, the cohesive Pt layer 10 on the surface of the silicon oxide mask 9 is removed and a planar surface is produced. A polishing fluid as described in the exemplary embodiments which follow is used to carry out the CMP step. The resulting structure is shown in FIG. 6.

The electrodes which have been formed by the patterning of the Pt layer 10 form the lower electrodes of the storage capacitors which are still to be produced. To complete them, it is still necessary for a dielectric/ferroelectric layer and a further electrode layer to be deposited and patterned. A process according to the invention can again be used to pattern the upper electrode.

Exemplary Embodiment 1

A platinum surface was treated with a polishing fluid aqueous suspension containing polycrystalline, synthetic diamond powder with a particle size of approximately 1 μm. The polishing pressure was set at 6.9 kPa (1 psi). The rotational speed of the polishing plate was 20 (rpm).

After a polishing time of 5 min, the surface roughness of the platinum surface was 3.5 nm (rms, measured using the AFM analysis method), with a maximum scratch depth of 20 nm. The abrasion rate under the conditions described above was 10 nm/min.

Exemplary Embodiment 2

A platinum surface was treated with a polishing fluid (Heraeus Kulzer Technotron diamond fluid MM 140, containing polycrystalline diamond particles with a particle size of approximately 1 μm and 25-50% by volume of white spirit, 0-5% by volume of ethanediol, remainder water) and an oxidizing agent (5% by weight of KClO₃ solution). The ratio of diamond suspension to KClO₃ solution was 5:1.

The polishing pressure was set at 13.8 kPa (2 psi). The rotational speed of the polishing plate was 30 rpm. After a polishing time of 3 min, it was possible to record an abrasion rate of 52 nm/min.

Exemplary Embodiment 3

A platinum surface was treated with the polishing fluid used in Exemplary Embodiment 2, while in the present example the oxidizing agent used was a mixture of 10% by weight of Na₂S₂O₈ solution and a 0.1% by weight of AgNO₃ solution. The ratio of diamond suspension to Na₂S₂O_{8/}AgNO₃ solution was 3:1. The polishing pressure was set at 13.8 kPa (2 psi) The rotational speed of the polishing plate was 30 rpm. After a polishing time of 3 min, the abrasion rate was 29 nm/min.

Exemplary Embodiment 4

A platinum surface was treated with an aqueous diamond suspension containing polycrystalline diamond particles with a particle size of approximately 0.1 μm (Masterprep Polishing Suspension from Bühler). The polishing pressure was set at 6.9 kPa (1 psi). The rotational speed of the polishing plate was 30 rpm.

After a polishing time of 3 min, it was possible to determine an abrasion rate of 6 nm/min.

Exemplary Embodiment 5

A platinum surface was treated with an aqueous diamond suspension containing polycrystalline diamond particles with a particle size of approximately 0.05 μm (Masterprep Polishing Suspension from Bühler). The polishing pressure was set at 6.9 kPa (1 psi). The rotational speed of the polishing plate was 30 rpm.

After a polishing time of 3 min, it was possible to determine an abrasion rate of 2 nm/min.

1. A polishing fluid, in particular for abrading and/or patterning metal oxides and metals, in particular elements from group 8b of the periodic system, by chemical mechanical polishing, containing
a) water or a water/alcohol mixture,
b) polycrystalline diamond powder, and
c) at least one additive selected from the group consisting of oxidizing agents, complex-forming agents, surfactants and organic bases.

2. The polishing fluid as claimed in claim 1, characterized in that the particle size of the polycrystalline diamond powder is less than approximately 1 μm.

3. The polishing fluid as claimed in claim 2, characterized in that the particle size of the polycrystalline diamond powder is between 0.05 and 1 μm, in particular between 0.1 and 1 μm.

4. The polishing fluid as claimed in one of claims 1 to 3, characterized in that the proportion of polycrystalline diamond powder in the polishing fluid is between 1 and 30% by weight.

5. The polishing fluid as claimed in one of claims 1 to 4, characterized in that the polycrystalline diamond powder is a synthetic diamond powder.

6. The polishing fluid as claimed in one of claims 1 to 5, characterized in that the additive is at least one oxidizing agent selected from the group consisting of oxygen, ozone (O₃), hydrogen peroxide (H₂O₂), peroxodisulfate in acid or alkaline solution, chlorine/oxygen compounds, such as for example hypochlorite, chlorate and perchlorate, bromine/oxygen compounds, such as for example bromate, iodine/oxygen compounds, such as for example iodate, manganese/oxygen compounds, such as for example permanganate, chromium/oxygen compounds, such as for example chromate, iron (III) compounds, such as for example Fe₂(SO₄), K₃Fe(CN)₆ and Fe(A)₃ where A=F, Cl, Br, I or (NO₃), cerium (IV) compounds, such as for example Ce(SO₄)₂ and Ce(NO₃)₄, nitrohydrochloric acid and chromosulfuric acid, it being possible to use the oxidizing agents alone or in combination.

7. The polishing fluid as claimed in one of claims 1 to 6, characterized in that the additive is at least one complex-forming agent selected from the group consisting of ethylenediaminetetraacetic acid (EDTA), nitrogen-containing crown ethers, citric acid, chloride ligands, bromide ligands, cyanide ligands and organometal coordination compounds based on phosphine ligands (PR₃, where R represents an organic radical).

8. The polishing fluid as claimed in claim 7, characterized in that the nitrogen-containing crown ether is a 1,4,8,11-tetraazacyclotetradecane derivative.

9. A process for planarizing and/or patterning a metal oxide layer or a metal layer, containing metals from group 8b of the periodic system, comprising the following steps:
a) a substrate is provided,
b) a metal oxide layer or a metal layer containing metals from group 8b of the periodic system is applied,
c) a polishing fluid containing polycrystalline diamond powder is provided, and
d) the metal oxide layer or the metal layer is planarized and/or patterned by means of a polishing step with the aid of the polishing fluid.

10. The process as claimed in claim 9, characterized in that the particle size of the polycrystalline diamond powder is less than approximately 1 μm.

11. The process as claimed in claim 10, characterized in that the particle size of the polycrystalline diamond powder is between 0.05 and 1 μm.

12. The process as claimed in one of claims 9 to 11, characterized in that the proportion of polycrystalline diamond powder in the polishing fluid is between 1 and 30% by weight.

13. The process as claimed in one of claims 9 to 12, characterized in that the polycrystalline diamond powder is a synthetic diamond powder.

14. The process as claimed in one of claims 9 to 13, characterized in that the polishing fluid contains at least one additive as set forth in one of claims 6 to 8.
